(19) United States
(12) Patent Application Publication
(10) Pub. No.: US 2003/0140169 A1
(43) Pub. Date: Jul. 24, 2003

(54) Profile splitting

(76) Inventors: Heikki Einola, Espoo (FI); Juha Back, Helsinki (FI); Heikki Lindholm, Espoo (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/168,218

(22) PCT Filed: Dec. 19, 2000
(86) PCT No.: PCT/IB00/02018

(30) Foreign Application Priority Data
Dec. 20, 1999 (GB) 9930087.3

(51) Int. Cl. G06F 15/16

(52) U.S. Cl. 709/245

(57) ABSTRACT

A communications network comprising: a connection data store for storing: a list of addresses accessible in the network, and associated with each address a list of connection types indicating the types of connection that can be made to that address, and associated with at least some of the pairings of address and connection type a respective identity of a terminal connected in the network; a connection identification unit for, when a connection is to be made in the network, identifying and address to which the connection is addressed and a desired type of the connection; a connection controller for receiving from the connection identification unit the address and type of the desired connection, searching the connection data store for a pairing of that address and service type, and on finding that pairing determining the associated terminal identity; and a routing unit for receiving that terminal identity and routing the connection to that terminal.

This invention relates to routing of connections in a communications system, for example routing calls in a radio telephone system.

A typical communications system supports calls that make use of any one of a number of data protocols, known as call types. Examples of call types include voice, data and fax. In order to succeed, each call must be routed to a receiving unit that is capable of handling the relevant data protocol—for instance, voice telephony calls may have to be routed to a telephone, data calls to a modem, fax calls to a facsimile machine. The receiving unit may be an individual item of terminal equipment. Alternatively, as in the GSM mobile telephone system, which will be described in more detail below, a single item of terminal equipment may contain several functions that are only in effect different receiving units.

There are two known ways to handle the routing. One option is the multi-numbering system. In that system individual address codes, normally corresponding to telephone numbers, are allocated to each of a user's receiving units. The initiator of the call then dials the code appropriate to the call type he wishes to use. With knowledge of the telephone number the network can easily route the call. The other option is the single numbering system. In that system a single address code, again normally a telephone number, is allocated to the user, and the network allots an individual identity to each of the user's receiving units, for example by means of identity information derived from an identity unit currently inserted into the unit. Those identities are stored by the network to allow it to route a call automatically to the appropriate one of the user's receiving units on the basis of the detected type of a call to the user.

In GSM a variety of the multi-numbering system is used. For each subscription to the system a user, known in that context as a subscriber, is allowed a single integrated circuit (IC) card or “SIM” (subscriber identity module) which carries his identification information. The identification information is held in the form of an IMSI (international mobile subscriber identity) which defines the home network to which the user is subscribed and his identity within that network. The user's home network has an HLR (home location register) unit that stores a list of user identities together with the address or telephone number (MSISDN) associated with each one.

In order to use the GSM system the user inserts his SIM in an item of GSM mobile equipment (ME). The combination of the SIM with the ME is known as a mobile station (MS). The MS registers with the network, during which process it transmits the IMSI from the SIM to the network. The network then provides the location of the user to the HLR in the user's home network. When an incoming call is received for the user's MSISDN the HLR of the user's home network is interrogated to find the location of the user. The HLR reports the location of the user. The call is then routed to the network in that location and a paging message is transmitted to inform the user's MS of the incoming call. The call is then connected to the user's MS.

In the GSM system the SIM card can store a number of user profiles to allow the user to have settings for various environments, e.g. work and home settings. Each user profile has a set of call types available and can store an address against each one. A subscriber can program each user profile with a different set of numbers, for example one profile could store a set of numbers for home use and another could store a set of numbers for work use. In the GSM system all of the user profiles for any user must be associated with a single SIM. This provides a simple route to avoid the possibility of the user registering more than once with the network at the same time by using different SIMs in different items of mobile equipment.

The GSM system does, however, impose a significant limitation: because a user with a single subscription can have only one SIM his calls cannot be directed to two separate items of mobile equipment. For example, it is not possible for a subscriber to have his voice calls directed to his telephone and his fax calls directed to a separate facsimile machine.

A standard is currently being developed for the proposed UMTS communications system. In the UMTS system a subscriber is again to be issued with an identifying IC card. This will hold one or more USIMs which store data that is in some ways analogous to the data stored in a GSM SIM: each USIM can store one or more user profiles of the type described above. Each subscriber will be allotted a single user address (MSISDN) by his service provider but each USIM will have a unique identification similar to the IMSI of the GSM system.

In the UMTS system there is a proposal to overcome the problems discussed above. ETS 22.01, issued by ETSI, relates to the proposed system. According to this proposal the following arrangements will be possible.

1. It will be possible to associate a single user profile with one or more USIMs which could be stored on different IC cards. This would allow a subscriber to be registered with the network simultaneously via multiple IC cards on different terminals for particular types of service: for example, on one terminal for fax and another terminal for voice telephony.

2. It will be possible to register simultaneously using more than one USIM on a single IC card, even when those USIMs are associated with different service providers. This would allow a user to make available simultaneously addresses that are provided to him by several service providers. There is a restriction that user profiles contained in USIMs shall not share the same user address.

These proposals raise new problems for network equipment that is to route calls to subscribers with these enhanced IC cards. Current network systems cannot cope with the first aspect of the proposal because it is currently assumed that each subscriber cannot be associated with more than one item of mobile equipment simultaneously. Current networks cannot cope with the second aspect of the invention because of the requirement that if a user activates profiles from more than one service provider they will have to have different user addresses; it is currently assumed that each address can only be associated with a single item of mobile equipment at any time.

There is therefore a need for a network system that can handle the proposed changes.

According to one aspect of the present invention there is provided a communications network comprising: a connection data store for storing a list of addresses accessible in the network, and associated with each address a list of connection types indicating the types of connection that can be made to that address, and associated with at least some of the pairings of address and connection type a respective identity of a terminal unit connected in the network; a connection identification unit for, when a connection is to be made in the network, identifying an address to which the connection is addressed and a desired type of the connection; a connection controller for receiving from the connection identification unit the address and type of the desired connection, searching the connection data store for a pairing of that address and service type, and on finding that pairing determining the associated terminal identity; and a routing unit for receiving that terminal identity and routing the connection to that terminal.

Preferably associated with each pairing of address and connection type the connection data store stores further information such as an indication of a service provider and/or an indication of the current state of the identified terminal. The state could include information on whether the terminal was currently available to receive the desired connection. Where the connection data store stores an indication of a service provider that service provider is preferably the service provider responsible for providing the associated address. The connection controller is suitably connected to one or more service provider databases for retrieving information from the appropriate service provider database on the basis of the indication of a service provider.

The connection identification unit suitably analyses information (such as bearer information) associated with the desired connection or information indicated in a request for the desired connection in order to the desired service type. The connection identification unit may be unable to identify a desired service type. To cope with this situation the connection controller is preferably capable of, on receiving from the connection identification unit an address of a desired connection without an associated connection type, searching the connection data store for a pairing of that address and a default service type, and on finding that pairing determining the associated terminal identity for use by the routing unit. In addition, it is preferred that the routing unit is capable of determining whether the connection has been made successfully to the identified terminal and, if the connection has not been successfully made, reporting that to the connection controller. Preferably the connection controller is capable of, on receiving such a report that a desired connection to an address has not been successfully made, searching the connection data store for a pairing of that address and a non-default service type, and on finding that pairing determining the associated terminal identity for use by the routing unit.

The non-default service type may be selected on the basis of a predetermined priority order of service types.

The said reporting to the connection controller may comprise reporting the type of service required for the connection, and the connection controller may be capable of, on receiving a report that a desired connection to an address has not been successfully made searching the connection data store for a pairing of the required type of service and that address and on finding such a pairing determining the associated terminal identity and causing the routing unit to route the connection to that terminal.

The network is preferably a mobile communications network, such as a UMTS network, suitably operating according to some or all of the UMTS protocol and/or proposal and/or standard.

One or both the connection data store and connection controller may be comprised or partially comprised in a home location register of a mobile communications network. One or both of the connection identification unit and the routing unit may be comprised or partially comprised in a mobile switching centre/gateway mobile switching centre of a mobile communications network.

According to the present invention from a second aspect there is provided a method for routing a connection in a communications network, comprising: storing in a connection data store: a list of addresses accessible in the network, and associated with each address a list of connection types indicating the types of connection that can be made to that address, and associated with at least some of the pairings of address and connection type a respective identity of a terminal connected in the network; identifying an address to which a desired connection is addressed, and a desired type of the connection; searching the connection data store for a pairing of that address and service type, and on finding that pairing determining the associated terminal identity; and routing the connection to that terminal.

The present invention will now be described by way of example with reference to the accompanying drawings, in which:

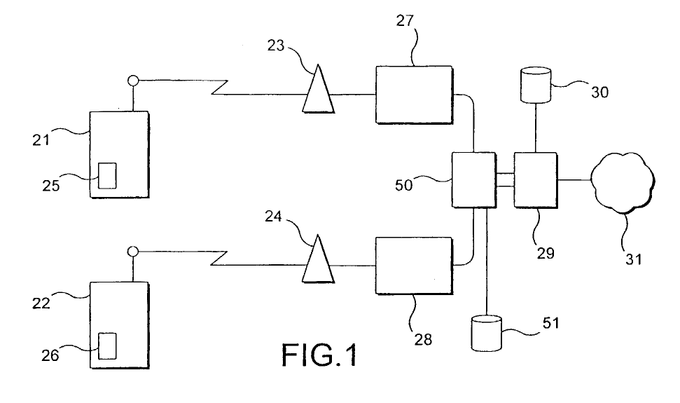

FIG. 1 is a schematic diagram of a communications system;

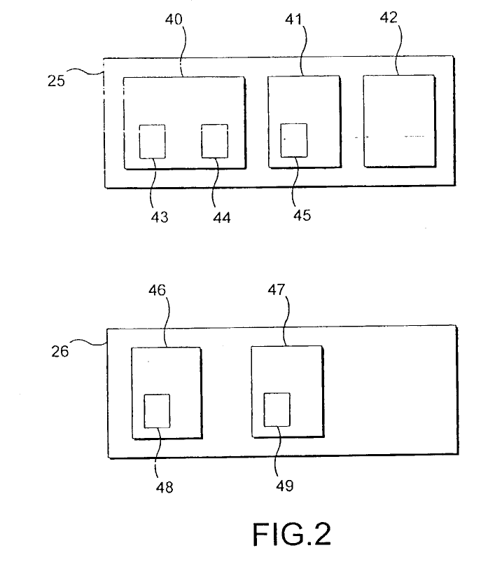

FIG. 2 is a schematic diagram of a pair of IC cards; and

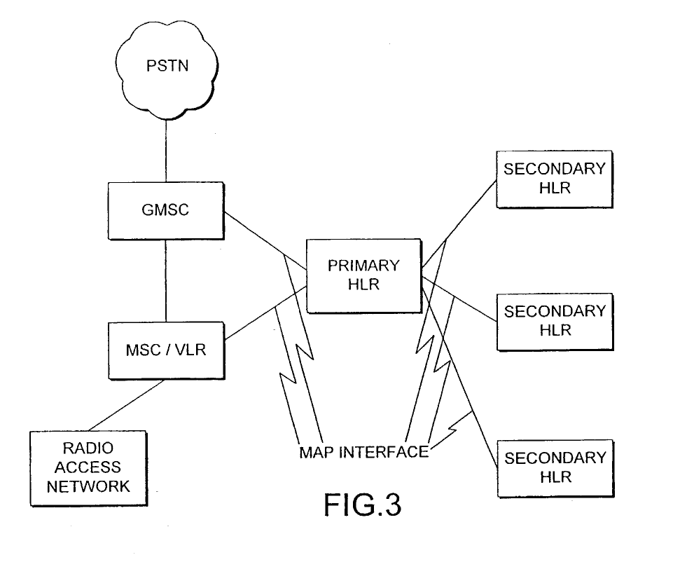

FIG. 3 shows a system including primary and secondary HLRs.

FIG. 1 shows the architecture of a UMTS communications system or the like. The present invention is equally applicable in other types of communications systems.

Two mobile stations (MSs) 21, 22 communicate by radio with respective base stations (BSs) 23, 24. Each mobile station holds an identity unit in the form of an IC card 25, 26. The IC cards hold subscriber identification information including one or more USIMs and, optionally, IC card applications. The base stations are connected to respective base station controllers (BSCs) 27, 28, also known as radio network controllers (RNCs), which are connected in turn via mobile switching centres (MSCs) 50, 51 to a gateway MSC (GMSC) 29. The GMSC is connected to a home location register (HLR) 30, which is a database storing subscriber data, and to a wider communications network indicated generally at 31, from which the UMTS system can receive incoming telephone calls and to which it can direct outgoing telephone calls. The UMTS system can also switch telephone calls internally between connected mobile stations. The system also includes visitor location registers (VLRs) 52, 53 connected to respective MSCs 50, 51. The VLRs store the details of mobiles that are currently registered within the area of the network covered by the base-stations controlled by their respective MSC.

In this example, the mobile stations 21, 22 are used by a single user who is a subscriber to the services of two service providers. FIG. 2 illustrates the information held in the IC cards 25, 26. Card 25 stores two USIMs 40, 41 and provides another application 42. USIM 40 is associated with a first service provider (SP1) and USIM 41 is associated with the other service provider (SP2). USIM 40 includes two user profiles 43, 44. USIM 41 includes one user profile 45. Each user profile lists a plurality of service types and the addresses that correspond to those service types. For example, user profile 43 could be:

| Address | Service(s) |
|---|---|
| 1 | Voice |
| 2 | Data |
| User profile 45 for SP 2 could be: | |
| 4 | Voice |
| 5 | Data, Fax |
| User profile 48 for SP 1 could be: | |
| 1 | Fax |

Card 26 stores two USIMs 46, 47, both of which are associated with the first service provider (SP1). Each of these USIMs includes a single respective user profile 48, 49.

As in the UMTS proposal described above, a user can activate more than one IC card at the same time, and can use more than one USIM at a time on each card, even if those USIMs are associated with different service providers. For instance, the user could activate IC cards 25 and 26 at the same time, allowing both mobile stations 21 and 22 to attach to the network simultaneously. The user can also activate, say, USIMs 40 (using user profile 43) and 41 on IC card 25 and USIMs 46 and 47 on IC card 26.

Each of the mobile stations has a unique identity. In this description mobile station 21 will be given the identity “MS 21” and mobile station 22 will be given the identity “MS 22”.

The network also needs to know the service provider associated with each USIM, to allow it to identify the location of further subscription information stored by that service provider.

When a mobile station registers with the system it transmits to a base station its identity (IMSI) for each activated USIM of its IC card (which includes an indication of the service provider: SP1 or SP2 in this example) and the current user profile. The network then contacts the service provider's database to obtain the address and corresponding service type information for those activated profiles. This information is stored in the HLR 30. The HLR thus keeps a database of location or routing information for each user that is registered with the system. For each address the HLR lists the service types with which that address is entitled or allowed to be used and against each of those lists an identity and a service provider location. For example, with mobile stations 21 and 22 registered with USIMs 40 (using user profile 43), 41 and 46 activated the HLR's database could store:

| MSISDN | Service | Identity | Location info. | State |
|---|---|---|---|---|
| 1 | Voice | IMSI 40 | VLR 52 | Attached |
| 2 | Data | IMSI 40 | VLR 52 | Attached |
| 4 | Voice | IMSI 41 | VLR 52 | Attached |
| 5 | Data | IMSI 41 | VLR 52 | Attached |
| 5 | Fax | IMSI 41 | VLR 52 | Attached |
| 1 | Fax | IMSI 46 | VLR 53 | Attached |

where the IMSI numbers relate to the corresponding USIM. An alternative arrangement is for specific service registration to be implemented. In such a system, a mobile station would indicate the services it wants to make available to allow, for example, a GMSC to take the proper action to handle mobile terminated calls when (say) a fax service has not been registered for but (say) a voice service has. This could happen in a single numbering scheme when a mobile station can make a registration when it cannot handle all services.

When the GMSC receives, either from the network 31 or from an internally connected terminal it first identifies the address to which the call is directed and, from the call's bearer code, the type of the call. Then the GMSC consults the HLR to identify where to direct the call. To do this the GMSC sends the HLR a request that indicates the identified address and service type.

The HLR then performs a search routine to establish where the call should be routed. The HLR searches its database to find whether there is a registration (corresponding to a row in the table above) for that address with that service. If there is such a registration then the HLR checks the state of that registration to find whether the appropriate mobile station is currently attached to the network or not. If the mobile station is currently attached then the HLR makes a roaming number enquiry towards the MSCNLR that is currently serving the MS. The roaming number will allow the call to be routed towards the MSCNLR. After receiving the routing number the HLR returns to the GMSC a message that indicates the identity (i.e. IMSI) of the MS and the roaming number (i.e. MSISDN pointing to the MSCNLR). The serving MSCNLR (which has the MSC/VLR that gave the roaming number) can then consult its database (i.e. VLR) to establish the location of the MS. Using this location information the MSCNLR can then start paging the appropriate BSCs to establish a connection between the MSCNLS and the MS. Once the MS has been found and the necessary actions (e.g. authentication and ciphering, assignment of a traffic channel etc.) have been completed the call setup can be completed. The routing is thus three-fold: by means of the MSISDN first to the GMSC (and HLR) e.g. from a PSTN, then from the HLR to the MSCNLR, and from the MSCNLR down to a location area that is comprised of a set of cells.

If the HLR cannot find a registration for that address with that service or if the HLR finds that the appropriate mobile station is not attached it returns an error message to the MSC, allowing the MSC to take appropriate action, for instance to make call forwarding, if activated.

It is possible that the HLR may not have knowledge of the service type of the call that is to be routed. For example, the call may have been originated from a system that does not support bearer codes. In that case the HLR could return an error message or could return the identity and location information for a default registration for the given address (assuming that registration is currently attached). The a registration could be indicated in its user profile of its USIM as being the default address, and this information stored by the HLR, or the HLR could treat registrations that support a certain service type (e.g. voice telephony) as being the default address.

The MSC (with VLR) controlling the MS might not able to connect the call. That may be because of a connection fault (e.g. radio interference) or because the mobile station to which the call has been directed is not capable of supporting the call's service type. The latter error could arise where the HLR has returned the details of a default registration that proved to be incompatible with the call. The MSC could then either reject the call or send the HLR a second message to request details of an alternative registration to which to route the call. In comparison with the GSM system there could be an enhancement, for example by providing OR (optimal routing) with new cause values, in order to provide the latter feature.

One other issue is that there could be more than one registration that is capable of accepting the call. The UMTS proposal avoids this possibility by including the restriction that registration of the same user profile on multiple terminals for the same type of service shall not be allowed. If the possibility were not banned in this way then the HLR would have to choose between the two available registrations, one way of making this choice would be to select the first suitable registration that is found, but more sophisticated systems are possible.

One way to implement the improved HLR with little modification from the architecture of an HLR for a GSM system is to split the functions of the HLR into primary and secondary functions. A single primary HLR unit would be connected to the MSC and that primary HLR would be connected to the service providers' databases by a plurality of secondary HLR units, one for each service provider. The primary HLR unit would hold the registration data mentioned above. The location information in each registration field indicates the service provider appropriate to each registration and on the basis of this the primary HLR could contact the appropriate secondary HLR to obtain further information. Thus each secondary HLR performs in a similar way to an HLR in a GSM system. The primary HLR is introduced as an intelligent interface between the MSC and the secondary HLRs. The primary HLR would contain pointers to the secondary HLRs (together with an indication of registered USIMs or just a list of registered USIMs), terminal ID and the location of the terminal. In this situation the primary HLR could handle mobility related issues: VLR addressing, attach/detach and a pointer to a secondary HLR. The secondary HLR could handle the specific services. This could allow mobility and service management to be split up. This arrangement is shown in FIG. 3.

The network described above may operate according to the UMTS system or another system; for example it could be an enhanced GSM system. The network could be a voice, data or other form of network.

The locations of the components of the system could be altered. For example, the functions of the HLR described above—especially its registration storage and processing functions—could be performed in a dedicated unit or in the another unit such as a GMSC (gateway MSC).

The present invention may include any feature or combination of features disclosed herein either implicitly or explicitly or any generalisation thereof, irrespective of whether it relates to the presently claimed invention. In view of the foregoing description it will be evident to a person skilled in the art that various modifications may be made within the scope of the invention.

1. A communications network comprising:
a connection data store for storing:
a list of addresses accessible in the network, and
associated with each address a list of connection types indicating the types of connection that can be made to that address, and
associated with at least some of the pairings of address and connection type a respective identity of a terminal connected in the network;
a connection identification unit for, when a connection is to be made in the network, identifying an address to which the connection is addressed and a desired type of the connection;
a connection controller for receiving from the connection identification unit the address and type of the desired connection, searching the connection data store for a pairing of that address and service type, and on finding that pairing determining the associated terminal identity; and
a routing unit for receiving that terminal identity and routing the connection to that terminal.

2. A communications network as claimed in claim 1, wherein associated with each pairing of address and connection type the connection data store stores an indication of a service provider.

3. A communications network as claimed in claim 2, wherein the connection controller is connected to a plurality of service provider databases for retrieving information from the appropriate service provider database on the basis of the indication of a service provider.

4. A communications network as claimed in any preceding claim, wherein the connection controller is capable of, on receiving from the connection identification unit an address of a desired connection without an associated connection type, searching the connection data store for a pairing of that address and a default service type, and on finding that pairing determining the associated terminal identity for use by the routing unit.

5. A communications network as claimed in claim 4, wherein the routing unit is capable of determining whether the connection has been made successfully to the identified terminal and, if the connection has not been successfully made, reporting that to the connection controller.

6. A communications network as claimed in claim 5, wherein the connection controller is capable of, on receiving a report that a desired connection to an address has not been successfully made, searching the connection data store for a pairing of that address and a non-default service type, and on finding that pairing determining the associated terminal identity for use by the routing unit.

7. A communications network as claimed in claim 6, wherein the non-default service type is selected on the basis of a predetermined priority order of service types.

8. A communications network as claimed in any of claims 5 to 7, wherein the said reporting to the connection controller comprises reporting the type of service required for the connection, and the connection controller is capable of, on receiving a report that a desired connection to an address has not been successfully made searching the connection data store for a pairing of the required type of service and that address and on finding such a pairing determining the associated terminal identity and causing the routing unit to route the connection to that terminal.

9. A communications network as claimed in any preceding claim, wherein the network is a mobile communications network.

10. A communications network as claimed in claim 8, wherein at least one of the connection data store and connection controller are comprised in the home location register of the mobile communications network.

11. A communications network as claimed in claim 9 or 10, wherein the mobile communications network operates according to the UMTS system.

12. A method for routing a connection in a communications network, comprising:
storing in a connection data store:
a list of addresses accessible in the network, and
associated with each address a list of connection types indicating the types of connection that can be made to that address, and
associated with at least some of the pairings of address and connection type a respective identity of a terminal connected in the network;
identifying an address to which a desired connection is addressed, and a desired type of the connection;
searching the connection data store for a pairing of that address and service type, and on finding that pairing determining the associated terminal identity; and
routing the connection to that terminal.
